(19) United States
(12) Patent Application Publication
(10) Pub. No.: US 2010/0310918 A1
(43) Pub. Date: Dec. 9, 2010

(54) UNIFIED AIR COOLING STRUCTURE OF HIGH-CAPACITY BATTERY SYSTEM

(76) Inventors: Jung Sik Yun, Daejeon (KR); Su Young Chang, Daejeon (KR); Jeon Keun Oh, Daejeon (KR)

Correspondence Address: ABELMAN, FRAYNE & SCHWAB, 666 THIRD AVENUE, 10TH FLOOR, NEW YORK, NY, 10017, US

(21) Appl. No.: 12/733,823

(22) PCT Filed: Sep. 16, 2008
(86) PCT No.: PCT/KR2008/005455

§ 371 Date: Jul. 12, 2010

(30) Foreign Application Priority Data
Sep. 20, 2007 (KR) 10-2007-0095925

(51) Int. Cl. H01M 10/50

(52) U.S. Cl. 429/120

(57) ABSTRACT

A uniform air blowing and cooling structure of a high capacity battery system includes a cell assembly having battery cells which are located in parallel at regular intervals while defining cooling channels therebetween; a housing accommodating the cell assembly therein and having a first space and a second space which are defined on both sides of the cell assembly perpendicular to a direction in which the cooling channels are defined; and an inlet and an outlet defined at both ends of the housing to respectively communicate with the first and second spaces defined in the housing, wherein the inlet is defined at one end of the first space and the outlet is defined at both ends of the second space so that air can flow along a substantially “h” shaped fluid path in the housing, whereby cooling of the battery cells in the respective cooling channels can be uniformly carried out.

### TECHNICAL FIELD

The present invention relates to a cooling structure of a high capacity battery system such as a lithium secondary battery, and more particularly, to a uniform air blowing and cooling structure of a high capacity battery system which can accomplish uniform cooling of respective battery cells in a high capacity battery system including a plurality of battery cells located with cooling channels defined therebetween.

### BACKGROUND ART

As is well known in the art, secondary batteries capable of recharging and discharging differently from primary batteries have actively been researched alongside the development of high technology fields for use in such as digital cameras, cellular phones, notebook computers, hybrid cars, and so forth. These secondary batteries include nickel-cadmium, nickel-metal hydride, nickel-hydrogen, and lithium secondary batteries. Among these batteries, the lithium secondary battery has an operation voltage greater than 3.6V and is used as a power source for portable electronic appliances or in a high performance hybrid car by connecting several or several tens of lithium secondary batteries in series. Compared to the nickel-cadmium battery or nickel-metal hydride battery, the lithium secondary battery has a three-fold higher operation voltage and an excellent energy density per unit weight characteristic, and therefore, the use of the lithium secondary battery is spreading rapidly.

The lithium secondary battery can be manufactured in a variety of types. The representative types of the lithium secondary battery include a cylinder type, which is mainly adopted for use in a lithium ion battery, and a prismatic type. A lithium polymer battery, which has been recently popular, is manufactured to be of the type comprising a pouch having flexibility so that its shape can be relatively freely adapted. Also, the lithium polymer battery has superior safety and is light in weight and is therefore advantageous when it comes to accommodating the trend toward slimness and lighter weight of electronic appliances.

The present invention is associated with a high capacity battery system used in the shape of a cell assembly in which a plurality of pouch type secondary batteries (for example, battery cells) are assembled with one another. A conventional example of the high capacity battery system will be described below with reference to FIGS. 1 and 2.

FIG. 1 is a perspective view schematically illustrating the outer appearance of a conventional lithium secondary battery system, and FIG. 2 is a plan view schematically illustrating the cooling structure of the system shown in FIG. 1.

Referring to FIGS. 1 and 2, a conventional lithium secondary battery system 100 includes a cell assembly 40 which is composed of a plurality of battery cells C₁, C₂, C₃, . . . defining cooling channels CH₁, CH₂, CH₃, . . . CHₙ therebetween, and a housing 10 which accommodates the cell assembly 40 therein and has an inlet 20 and an outlet 30 at both respective ends thereof. The lithium secondary battery system 100 has a cooling structure which possesses a ‘Z’-shaped fluid path formed by the inlet 20, the outlet 30, and the plurality of cooling channels 50 defined between the inlet 20 and the outlet 30, for example, 88 cooling channels CH₁, CH₂, CH₃, . . . , CHₙ where n=88.

For example, a first space 60 and a second space 70, which are defined on both respective sides of the cell assembly 40 in the housing 10, respectively communicate with the inlet 20 and the outlet 30. The first space 60 and the second space 70 also communicate with each other through the plurality of cooling channels 50. Therefore, the Z-shaped fluid path is formed in the sequence of the inlet 20, the first space 60, the plurality of cooling channels 50, the second space 70, and the outlet 30.

In the conventional lithium secondary battery system having the Z-shaped fluid path, air (cooling media) introduced into the system through the inlet passes through the system (for example, the cooling channels) toward the outlet. Attributable to this fact, the battery cells adjoining the cooling channels, through which air passes, are cooled. However, in such a cooling structure, a phenomenon in which air flow is concentrated on some of the cooling channels occurs so that the cooling efficiency of the entire system is not uniformly distributed. This is problematic.

For instance, in the case of the system shown in FIG. 1, when comparing the cooling efficiencies of the respective cooling channels by sequentially numbering the 88 cooling channels in the direction extending from the inlet toward the outlet, it was found that the cooling efficiencies of the cooling channels adjacent to the outlet (that is, the cooling channels having large numbers) are greater than those of the cooling channels adjacent to the inlet (that is, the cooling channels having small numbers). Also, even in the case of changing the sizes of the inlet and the outlet and the sizes of the first and second spaces, due to the characteristics of the cooling structure having the Z-shaped fluid path, it was found that it is impossible to accomplish uniform air blowing over the entirety of cooling channels.

As a result, in the conventional lithium secondary battery system having the Z-shaped fluid path, since the plurality of cooling channels have different cooling efficiencies, the battery cells located adjoining the respective cooling channels are cooled to different degrees, and therefore, the cooling efficiency of the entire system is degraded.

### DISCLOSURE

### Technical Problem

An object of the present invention is to provide a uniform air blowing and cooling structure of a lithium secondary battery system having a plurality of cooling channels, which allows a uniform amount of air to pass through the respective cooling channels.

Another object of the present invention is to provide a uniform air blowing and cooling structure of a high capacity battery system (a lithium secondary battery system), which can uniformly cool battery cells adjoining respective cooling channels by allowing a uniform amount of air to pass through the respective cooling channels.

### Technical Solution

In order to achieve the above objects, according to one aspect of the present invention, there is provided a uniform air blowing and cooling structure of a high capacity battery system, comprising a cell assembly having a plurality of battery cells which are located in parallel at regular intervals while defining cooling channels therebetween; a housing accommodating the cell assembly therein and having a first space and a second space which are defined on both sides of the cell assembly perpendicular to a direction in which the cooling channels are defined; and an inlet and an outlet defined at both ends of the housing to respectively communicate with the first and second spaces defined in the housing, wherein the inlet is defined at one end of the first space and the outlet is defined at both ends of the second space so that air can flow along a substantially ‘h’-shaped fluid path in the housing, whereby cooling of the battery cells in the respective cooling channels can be uniformly carried out.

According to another aspect of the present invention, the outlet comprises a first outlet which corresponds to the inlet and a second outlet which faces away from the first outlet, and a sectional area of the first outlet is smaller than a sectional area of the second outlet.

According to another aspect of the present invention, a ratio between the sectional areas of the first outlet and the second outlet is 2:5.

According to another aspect of the present invention, the cell assembly has at least 90 battery cells.

According to still another aspect of the present invention, at least one blower fan is installed in the inlet to introduce outside air into the housing.

According to a still further aspect of the present invention, the housing comprises a base plate on which the cell assembly is supported and a cover which is coupled with the base plate to form a space for accommodating the cell assembly and is substantially of the sectional shape of ‘∩’ such that the first and second spaces are defined between the cell assembly and the cover.

### Advantageous Effects

Thanks to the above-described features, in the cooling structure of a high capacity battery (lithium secondary battery) system according to the present invention, which has cooling channels defined between battery cells located at regular intervals, air (cooling medium) is blown through an inlet, the cooling channels, and an outlet. At this time, due to the fact that the outlet is composed of two opposite outlets, uniform air blowing through the respective cooling channels can be accomplished. Therefore, as the amounts of air passing through the respective cooling channels become uniform, a substantially uniform cooling effect can be attained for all the battery cells located adjoining the respective cooling channels.

### DESCRIPTION OF DRAWINGS

FIG. 1 is a schematic perspective view illustrating an example of a conventional lithium secondary battery system;

FIG. 2 is a plan view schematically illustrating the cooling structure of the system shown in FIG. 1;

FIG. 3 is a schematic perspective view illustrating a lithium secondary battery system in accordance with an embodiment of the present invention;

FIG. 4 is a partially broken-away perspective view illustrating the state in which a cover shown in FIG. 3 is partially broken away;

FIG. 5 is a plan view schematically illustrating the cooling structure of the system shown in FIG. 3;

FIG. 6 is a graph showing air blowing results for respective channels in the cooling structure of FIG. 5;

FIG. 7 is a graph showing first exemplary air blowing results in the cooling structure of FIG. 2, as a first comparative example with respect to FIG. 6;

FIG. 8 is a graph showing second exemplary air blowing results in the cooling structure of FIG. 2, as a second comparative example with respect to FIG. 6;

FIG. 9 is a graph showing third exemplary air blowing results in the cooling structure of FIG. 2, as a third comparative example with respect to FIG. 6; and

FIG. 10 is a graph showing fourth exemplary air blowing results in the cooling structure of FIG. 2, as a fourth comparative example with respect to FIG. 6.

### DESCRIPTION OF REFERENCE NUMERALS FOR MAIN PARTS IN DRAWINGS

100, 200: cooling structure
10, 110: housing
20, 120: inlet
30, 130a, 130b: outlet
40, 140: cell assembly
50, 150: cooling channel
60, 160: first space
70, 170: second space
112: base plate
114: cover
116: locking holes
122: blower fan
C₁, C₂, C₃, . . . : battery cells
CH₁, CH₂, CH₃, . . . , CHₙ: cooling channels

### Mode for Invention

Reference will now be made in greater detail to a preferred embodiment of the invention, an example of which is illustrated in the accompanying drawings.

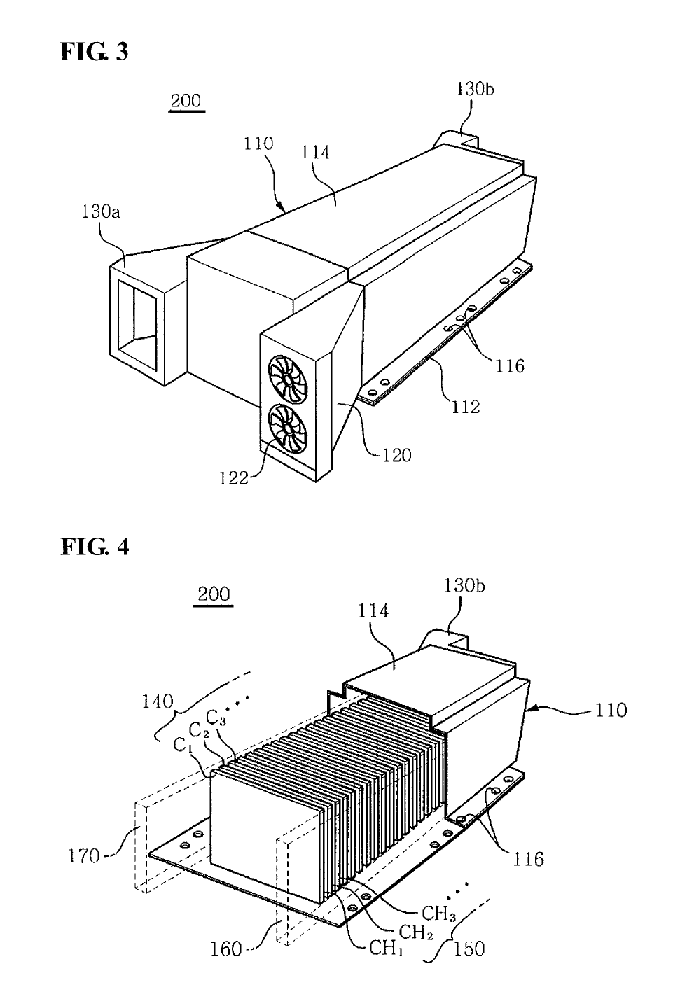

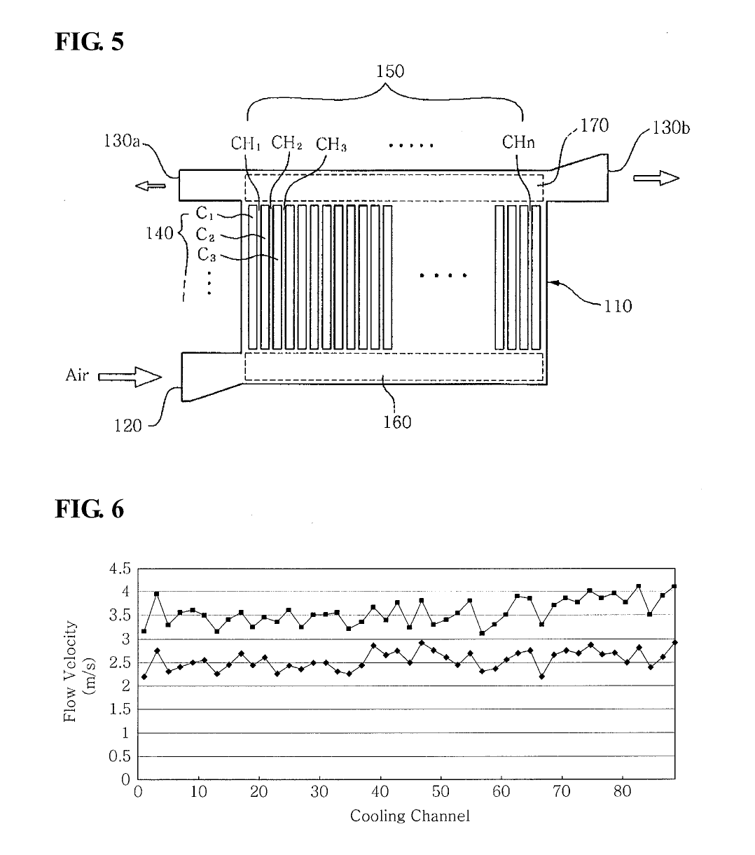

FIG. 3 is a perspective view schematically illustrating the outer appearance of a lithium secondary battery system in accordance with an embodiment of the present invention, FIG. 4 is a partially broken-away perspective view illustrating the state in which a cover shown in FIG. 3 is partially broken away, and FIG. 5 is a plan view schematically illustrating the cooling structure of the system shown in FIG. 3.

Referring to FIGS. 3 through 5, a lithium secondary battery system 200 in accordance with an embodiment of the present invention includes a cell assembly 140 which is composed of a plurality of battery cells C₁, C₂, C₃, . . . defining cooling channels CH₁, CH₂, CH₃, . . . CHₙ therebetween, and a housing 110 which accommodates the cell assembly 140 therein and has an inlet 120 and a pair of outlets 130a and 130b at both ends thereof. The lithium secondary battery system 200 has a cooling structure which possesses an ‘h’-shaped fluid path formed by the inlet 120, the pair of outlets 130a and 130b, and the plurality of cooling channels 150 defined between the inlet 120 and the pair of outlets 130a and 130b, for example, 88 cooling channels CH₁, CH₂, CH₃, . . . , CHₙ where n=88.

For example, a first space 160 and a second space 170, which are defined on both respective sides of the cell assembly 140 in the housing 110, respectively communicate with the inlet 120 and the pair of outlets 130a and 130b. The first space 160 and the second space 170 also communicate with each other through the plurality of cooling channels 150. Therefore, the h-shaped fluid path is formed in the sequence of the inlet 120, the first space 160, the plurality of cooling channels 150, the second space 170, and the pair of outlets 130a and 130b.

That is to say, in the first and second spaces 160 and 170 which are defined on both sides of the cell assembly 140 in the housing 110, the first space 160 communicates with the inlet 120 at one end thereof, and the second space 170 communicates with the pair of outlets 130a and 130b at both respective ends thereof.

As shown in FIG. 4, such a cooling structure can be formed by the housing 110 having a base plate 112 on which the cell assembly 140 is placed and a cover 114 which is positioned on the base plate 112 to cover the cell assembly 140 and has substantially the sectional shape of ‘∩’ to define the first and second spaces 160 and 170 on both sides of the cell assembly 140. In this structure, it is to be readily understood that, for example, by changing the locking positions between the cover 114 and the base plate 112 (that is, the positions of locking holes 116), the sizes (sections) of the first and second spaces can be adjusted. The change of the locking positions can be performed by appropriately locating various locking means (for example, bolts, nuts, rivets, etc.) which are used to lock the base plate and the cover to each other.

While it is illustrated in the drawings that the positions of the locking holes 116 are fixed, it is apparent that the positions of the locking holes defined in any one of the base plate and the cover can be changed so as to adjust the sizes of the first and second spaces.

In the lithium secondary battery system having the h-shaped fluid path, air (cooling medium) introduced into the system through the inlet defined on one side of the cell assembly uniformly passes through the system (for example, the cooling channels) toward the pair of outlets defined on both ends of the other side of the cell assembly. Attributable to this fact, the battery cells adjoining the cooling channels, through which air passes, are cooled. Therefore, in such a cooling structure, as air passes in an evenly distributed manner through the entirety of the plurality of cooling channels, the cooling efficiencies of the respective cooling channels become uniform, and the cooling efficiency of the entire system can be improved.

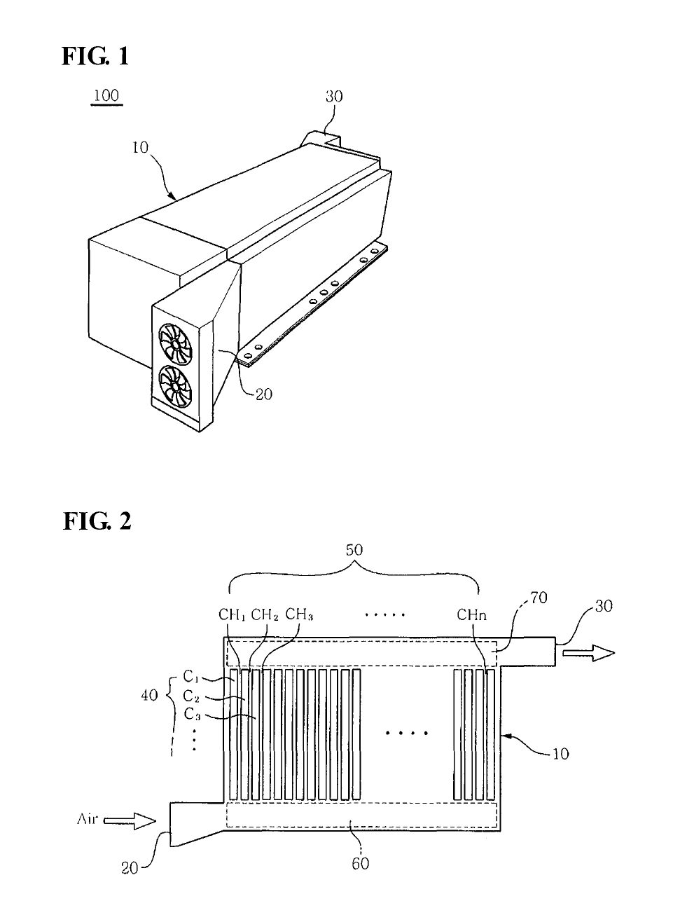

For instance, in the case of the system shown in FIG. 1, when comparing the cooling efficiencies of the respective cooling channels by sequentially numbering the 88 cooling channels in the direction extending from the first outlet 130a corresponding to the inlet 120 toward the second outlet 130b facing away from the first outlet 130a, it was found that the cooling efficiencies of the cooling channels adjacent to the first outlet 130a (that is, the cooling channels having small numbers) are similar to those of the cooling channels adjacent to the second outlet 130b (that is, the cooling channels having large numbers).

That is to say, in the present invention, unlike the conventional art, since the pair of outlets are defined divisionally on both ends of the other side of the cell assembly, air (cooling medium) passing through the system can be evenly distributed toward the pair of outlets, and uniform cooling efficiencies can be attained for the entirety of the respective cooling channels.

These characterizing features of the present invention will be demonstrated below using simple experimental results.

Based on the fact that the amount of air (cooling medium) passing through a cooling channel which has a constant size is proportional to the flow rate of air passing through the cooling channel, the present applicant fabricated, for example, simulation models each having 88 cooling channels and used a velocimetry apparatus to measure the flow rates of the cooling medium (air) through the respective channels.

In detail, experiments were conducted based on models each having 88 cooling channels, a velocimetry apparatus capable of measuring the flow rates of air passing through the cooling channels, and an inlet through which air is introduced into the system and an outlet through which air having passed through the cooling channels is discharged out of the system.

Further, a model according to the present invention, in which the outlet comprises a first outlet defined at one end of a housing where the inlet is defined and a second outlet defined at the other end of the housing facing away from the one end, and a comparative model according to the conventional art, in which one inlet and out outlet are defined, were prepared. Also, in the comparative model according to the conventional art, the sizes (sections) of the inlet and the outlet were changed so that various comparative examples can be obtained to be compared with the present invention.

For reference, the 88 cooling channels were numbered from 1 to 88 in the direction extending from the inlet toward the second outlet in the case of the present invention or the outlet in the case of the conventional art. In order to measure the flow rates of air in the respective cooling channels, a hot wire velocimetry apparatus was used. For convenience' sake, the flow rates of air were not measured for all the cooling channels, but measured only for odd-numbered cooling channels, for example 1^{st}, 3^{rd}, 5^{th}, 7^{th}, . . . , 85^{th}, 87^{th} and 88^{th} cooling channels.

Because blower fans are installed in the inlet to provide the introduction of air into the system, it is preferred that a duct be provided for the inlet. On the other hand, in the case of the outlet, an exit duct may be formed, or only a discharge opening may be defined without using a duct. For example, in the case of the inlet, the amount of air introduced into the system can be adjusted depending upon the shape of the inlet. Unlike this, in the case of the outlet, it is apparent that the outlet may have any shapes so long as air introduced through the inlet into the system can be smoothly discharged to the outside. Also, the amount of air introduced into the system can be adjusted depending upon the shape of the inlet as well as the performance of the blower fans which are installed in the inlet. For example, by changing the level of power supplied to the blower fans, the amount of air introduced into the system can be adjusted.

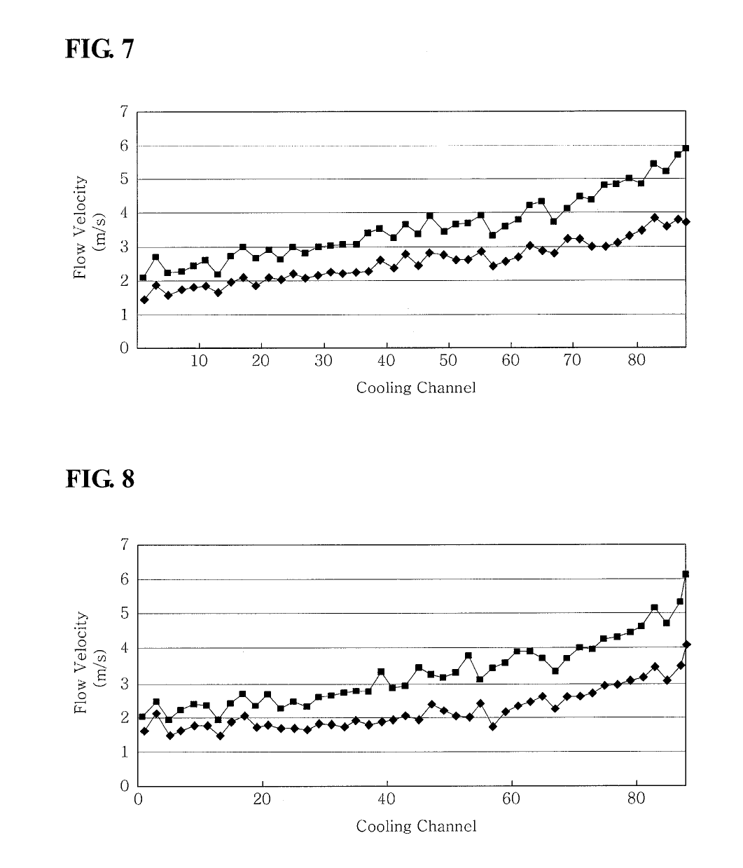

FIG. 6 is a graph showing air blowing results for the respective channels in the cooling structure of FIG. 5, and FIGS. 7 through 10 are graphs showing air blowing results in the cooling structure of FIG. 2, as first through fourth comparative examples to be compared with FIG. 6. At this time, the respective comparative examples indicate results that were obtained by changing the sizes (sections) of the inlet and outlet in the conventional model which is defined with one inlet and one outlet.

Referring to FIG. 6, it is to be understood that, when defining the first outlet and the second outlet according to the present invention, substantially uniform flow rates are obtained for most cooling channels. At this time, the width of one end of the first space where the inlet is defined was 50 mm, and the width of the other end of the first space was 3 mm. Further, the width of one end of the second space where the first outlet is defined was 20 mm, and the width of the other end of the second space where the second outlet is defined was 50 mm. In FIG. 6, the line having square marks ▪ indicates the case in which power of 12V 1.85 A is supplied to the blower fans, and the line having rhombic marks ♦ indicates the case in which power of 8V 1.12 A is supplied to the blower fans. By observing these lines, it is to be understood that air flows with substantially uniform flow rates irrespective of the power supply levels. As a consequence, it can be appreciated that the cooling structure according to the present invention characterized in that the two outlets (the first outlet and the second outlet) are defined can attain uniform cooling for the respective cooling channels and the entire system can be cooled in an efficient manner.

Next, FIGS. 7 through 10 are graphs showing the results of the experiments conducted in the comparative model (for example, the model having one inlet and one outlet) to be compared with the cooling structure of the present invention and respectively represent first through fourth comparative examples.

These comparative examples were designed on the same principle as the model (the system cooling structure model) according to the present invention, except that the sizes and the numbers of the inlet and outlet are different. For example, the model applied to these comparative examples is different from the model according to the present invention in that it has a single outlet. Also, the respective comparative examples are different from one another as described below.

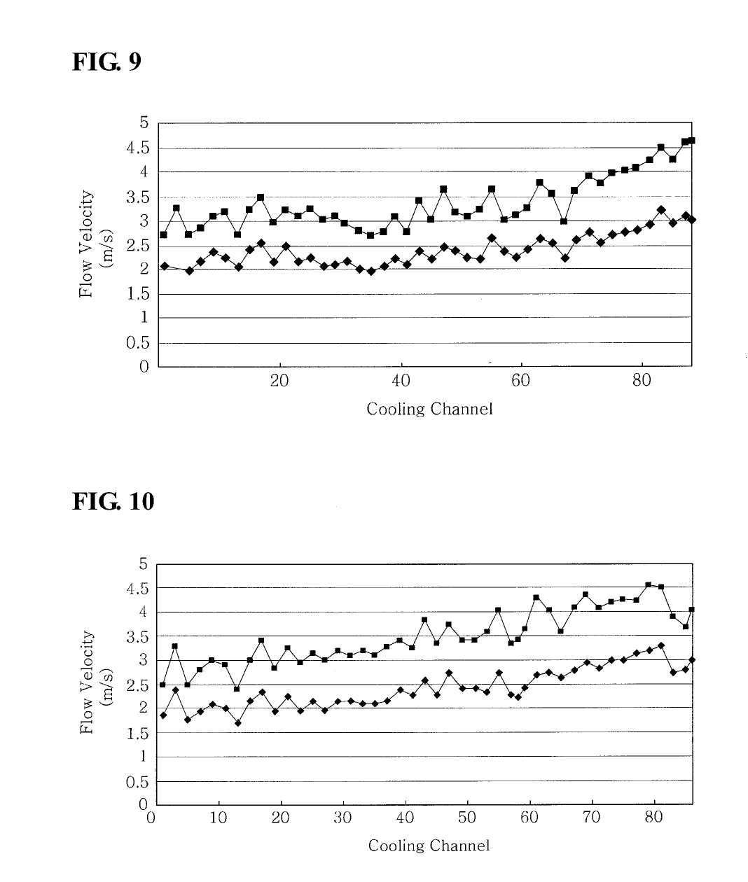

The comparative experiments were conducted under the same conditions except for the following differences. In the first comparative example shown in FIG. 7, the width of one end of the first space where the inlet is defined was 50 mm, and the width of the other end of the second space where the outlet is defined was 50 mm. In the second comparative example shown in FIG. 8, the width of one end of the first space where the inlet is defined was 50 mm and the width of the other end of the first space was 3 mm, and the width of the other end of the second space where the outlet is defined was 30 mm and the width of one end of the second space was 50 mm. In the third comparative example shown in FIG. 9, the width of one end of the first space where the inlet is defined was 50 mm and the width of the other end of the first space was 2 mm, the width of the intermediate portion of the first space was 20 mm, and the width of the other end of the second space where the outlet is defined was 50 mm. In the fourth comparative example shown in FIG. 10, the width of one end of the first space where the inlet is defined was 50 mm and the width of the other end of the first space was 2 mm, and the width of the other end of the second space where the outlet is defined was 50 mm.

Further, similar to FIG. 6, in these drawings (FIGS. 7 through 10), the line having square marks ▪ indicates the case in which power of 12V 1.85 A is supplied to the blower fans, and the line having rhombic marks ♦ indicates the case in which power of 8V 1.12 A is supplied to the blower fans.

The results of the experiments that were conducted under these experimental conditions to be compared with the graph of FIG. 6 are shown in FIGS. 7 through 10. Unlike the case of FIG. 6, these comparative examples indicate that the flow rates in the cooling channels adjacent to the outlet (that is, the cooling channels having large numbers such as 85, 87 and 88) are greater than those in the cooling channels adjacent to the inlet (that is, the cooling channels having small numbers such as 1, 3 and 5). This means that an increased amount of air flows in the cooling channels adjacent to the outlet and the cooling efficiencies of the battery cells adjoining the cooling channels located adjacent to the outlet are greater than those of the battery cells adjoining the cooling channels located adjacent to the inlet.

As a consequence, the graphs of FIGS. 7 through 10, which are associated with the system having a single inlet and a single outlet, indicate that a larger amount of air flows through the cooling channels adjacent to the outlet than the cooling channels adjacent to the inlet and the battery cells adjacent to the outlet are cooled better than the battery cells adjacent to the inlet, which results in the degradation of the overall cooling efficiency when compared to the uniform air blowing by the cooling structure (for example, the system having two outlets) according to the present invention.

As is apparent from the above description, the uniform air blowing and cooling structure according to the present invention provides advantages in that, since substantially uniform air blowing is induced for cooling channels defined between battery cells, a uniform cooling effect can be attained for the entirety of battery cells. To this end, the uniform air blowing and cooling structure according to the present invention has a structural feature in that an outlet for discharging air out of a battery system is composed of two outlets unlike the conventional art which has only one outlet. Due to this fact, since air is discharged through the two outlets (in particular, a first outlet and a second outlet which are formed oppositely at both ends of a second space), uniform cooling of the respective cooling channels can be ensured.

These characteristics are experimentally supported by the graphs attached in the drawings (FIG. 6 showing the results of the present invention and FIGS. 7 through 10 showing the results of the comparative examples 1 through 4).

1. A uniform air blowing and cooling structure of a high capacity battery system, comprising:
a cell assembly having a plurality of battery cells which are located in parallel at intervals while defining cooling channels therebetween;
a housing accommodating the cell assembly therein and having a first space and a second space which are defined on both sides of the cell assembly perpendicular to a direction in which the cooling channels are defined; and
an inlet and an outlet defined at both sides of the housing to respectively communicate with the first and second spaces defined in the housing,
wherein the inlet is defined at one end of the first space and the outlet is defined at both ends of the second space so that air can flow along a substantially ‘h’-shaped fluid path in the housing, whereby cooling of the battery cells in the respective cooling channels can be uniformly carried out.

2. A uniform air blowing and cooling structure of a high capacity battery system according to claim 1, wherein the outlet comprises a first outlet which corresponds to the inlet and a second outlet which faces away from the first outlet, and a sectional area of the first outlet is smaller than a sectional area of the second outlet.

3. A uniform air blowing and cooling structure of a high capacity battery system according to claim 2, wherein a ratio between the sectional areas of the first outlet and the second outlet is 2:5.

4. A uniform air blowing and cooling structure of a high capacity battery system according to claim 1, wherein at least one blower fan is installed in the inlet to introduce outside air into the housing.

5. A uniform air blowing and cooling structure of a high capacity battery system according to claim 1, wherein the housing comprises a base plate on which the cell assembly is supported and a cover which is coupled with the base plate to form a space for accommodating the cell assembly and has substantially the sectional shape of ‘∩’ such that the first and second spaces are defined between the cell assembly and the cover.
